(19) United States
(12) Patent Application Publication
(10) Pub. No.: US 2016/0050289 A1
(43) Pub. Date: Feb. 18, 2016

(54) AUTOMATIC SHARING OF DIGITAL CONTENT

(71) Applicants: David M. Cohen, Mountain View, CA (US); Matthew S. Steiner, Mountain View, CA (US); Thomas Ho-min Kang, Santa Monica, CA (US); Anton Lopyrev, San Francisco, CA (US); Todd Bogdan, Santa Barbara, CA (US)

(72) Inventors: David M. Cohen, Mountain View, CA (US); Matthew S. Steiner, Mountain View, CA (US); Thomas Ho-min Kang, Santa Monica, CA (US); Anton Lopyrev, San Francisco, CA (US); Todd Bogdan, Santa Barbara, CA (US)

(73) Assignee: GOOGLE INC., Mountain View, CA (US)

(21) Appl. No.: 13/533,584

(22) Filed: Jun. 26, 2012

(51) Int. Cl. H04L 29/08

(52) U.S. Cl. CPC H04L 67/30

(57) ABSTRACT

Methods, systems, and apparatus, including computer programs encoded on a computer storage medium, for determining that an event is occurring, in response to determining that the event is occurring, setting a sharing mode of a computing device to an automatic sharing mode, determining that first digital content has been generated, and in response to the automatic sharing mode and determining that the first digital content has been generated: automatically transmitting, to one or more servers, a first digital content file associated with the first digital content and instructions for distributing the first digital content using the one or more social networking services.

### TECHNICAL FIELD

This specification generally relates to sharing of digital content using one or more social networking socials.

### BACKGROUND

Users of devices generate digital content including digital images (e.g., photographs) and/or digital video to, among other reasons, document events and keep memories. People often share the digital content with friends and family. In recent years, sharing of digital content using one or more computer-implemented services (e.g., social networking services) has become more mainstream. In some examples, users can attach digital content to electronic messages and/or post digital content on websites for others to view. Social networking websites are also used to share digital content with social networking contacts.

### SUMMARY

In general, innovative aspects of the subject matter described in this disclosure may be embodied in methods that include actions of determining that an event is occurring, in response to determining that the event is occurring, setting a sharing mode of a computing device to an automatic sharing mode, determining that first digital content has been generated, and in response to the automatic sharing mode and determining that the first digital content has been generated: automatically transmitting, to one or more servers, a first digital content file associated with the first digital content and instructions for distributing the first digital content using the one or more social networking services. Other implementations of this aspect include corresponding systems, apparatus, and computer programs, configured to perform the actions of the methods, encoded on computer storage devices.

These and other implementations may each optionally include one or more of the following features. For instance, the first digital content is distributed based on a default distribution, the default distribution being an event-specific distribution; actions further include receiving first input, the first input editing the default distribution to provide an edited distribution, wherein the first digital content is distributed based on the edited distribution; the edited distribution includes the event-specific distribution and a user-defined distribution; one or more users of the user-defined distribution are absent from the event-specific distribution; actions further include, in response to setting the automatic sharing mode, generating an indicator, the indicator indicating that the computing device is operation in the automatic sharing mode; the indicator including a visual indicator that is displayed on a display of the computing device; the indicator includes an audible indicator that is emitted from the computing device; actions further include displaying an interface on a display of the computing device, the interface including one or more icons, each icon being selectable to define a distribution for digital content that is to be automatically shared using the computing device; at least one icon of the one or more icons graphically represents a social grouping defined by a user of the computing device within at least one of the one or more social networking services; the one or more icons graphically represent respective social groupings defined by a user of the computing device within at least one of the one or more social networking services; actions further include receiving first input, the first input including selection of a manual sharing mode of the computing device such that user input is required to transmit, to the one or more servers, digital content files associated with digital content and instructions for distributing the digital content using the one or more social networking services; the digital content includes at least one of a digital image and a digital video; setting the sharing mode of a computing device to the automatic sharing mode is further in response to determining that the user is in attendance at the event; determining that the user is in attendance at the event is based on at least one of one or more implicit signals and one or more explicit signals; the one or more implicit signals include one or more of a current time, a current date and a current location of the computing device; the event is defined based on one or more event parameters; and determining that the event is occurring includes comparing the one or more event parameters to one or more respective actual parameters.

Implementations of the present disclosure provide one or more of the following example advantages: eases process of uploading digital content (automatic, and selecting the distribution once per set of digital content instead, or pre event, instead of on a per-digital content basis), digital content is shared with a specific audience (e.g., event participants for an event, face-tagged users in the included content), improved speed of delivery of digital content (e.g., near real-time upload and near real-time delivery of digital content to all relevant parties), and the ability to aggregate digital content across users for sharing.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 depicts an example system that can execute implementations of the present disclosure.

FIG. 2 depicts an example social network including social groupings.

FIG. 3 depicts an example graphical user interface for creating, editing and/or maintaining social groupings.

FIGS. 4A-4D depict an example mobile device displaying an example interface for automatically sharing digital content.

FIG. 5 depicts an example stream page for a user of a social networking service.

FIG. 6 depicts an example process for automatic sharing of digital content.

Like reference numbers represent corresponding parts throughout.

### DETAILED DESCRIPTION

Implementations of the present disclosure are generally directed to automatic sharing of digital content using one or more computer-implemented social networking services. In some examples, digital content can include digital images, digital video, text and/or other appropriate digital content. In some examples, a user can generate digital content that is automatically uploaded to one or more servers and shared, or published, to a viewing audience of the one or more social networking services. In some examples, automatic sharing can be achieved in response to generation of the digital content without user interaction that triggers sharing of the digital content to the one or more social networking services. In some examples, digital content can be automatically shared to one or more social groupings associated with a social networking service. For example, the user can select one or more social groupings for automatic sharing of digital content. Automatic sharing can be achieved in response to generation of the digital content without user interaction that triggers sharing of the digital content to the one or more social groupings. In this manner, generated digital content is automatically uploaded to the social networking service and shared to members of the one or more social groupings without further action by the user.

In some implementations, automatic sharing can be triggered based on one or more events. In some examples, a sharing mode of a device that is used to generate digital content can be switched to automatic sharing in response to occurrence of and/or attendance at an event. In some examples, the sharing mode can be switched to manual sharing in response to ending of and/or departure from the event. In some implementations, an event can be associated with a time, a date and/or a location. In some examples, it can be determined that the event is occurring when a current time, a current date and/or a location of the device corresponds to the time, the date and/or the location, respectively, of the event. In some examples, attendance at an event can be determined based on implicit and/or explicit indications. For example, it can be determined that a current location of the device is at or is within a threshold distance of the location of the event and, in response, it can be determined that the device is at the event. As another example, a user of the device can use the device to “check-in” to the event and/or a location of the event and, in response it can be determined that the device is at the event.

In some implementations, the distribution of automatically shared digital content can be provided based on one or more event-specific social groupings. In some examples, an event host can define one or more social grouping that are associated with the event. In this manner, digital content generated during or at the event can be automatically shared to each of the one or more event-specific social groupings. In some examples, members of the one or more event-specific social groupings can include actual attendees of the event (e.g., users that are actually present at the event) and/or invited attendees of the event (e.g., users that were invited to the event, but are not present at the event).

For purposes of illustration, implementations of the present disclosure are described within the context of an example social networking service. The example social networking service enables users to organize contacts into social groupings. It is appreciated, however, that implementations of the present disclosure can be used in other types of social networking services and are not limited to social networking services that include social groupings.

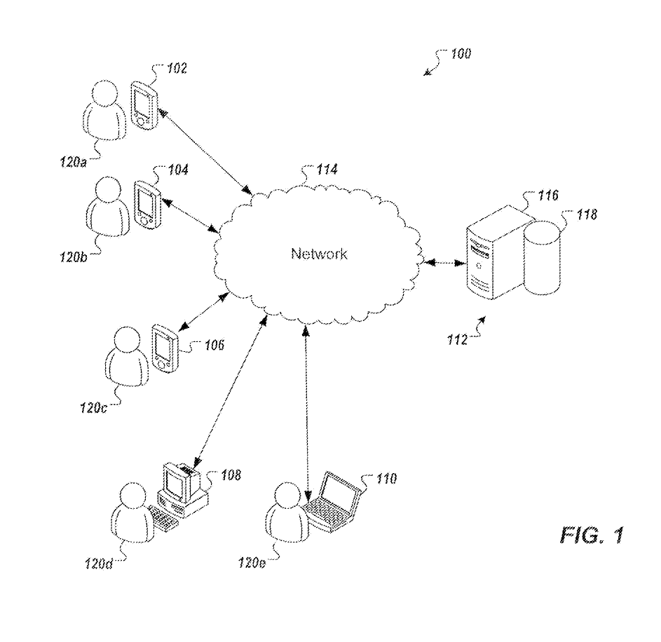

FIG. 1 depicts an example network architecture 100 that can be used to execute implementations of the present disclosure. The network architecture 100 includes a number of client devices 102-110 communicably connected to a server device 112 by a network 114. The server device 112 includes a processing device 116 and a data store 118. The processing device 116 executes computer instructions (e.g., program code) stored in the data store 118 to perform functions.

In some implementations, the client devices 102-110 can be computing devices such as laptop or desktop computers, smartphones, personal digital assistants, portable media players, tablet computers, or other appropriate computing devices. In some implementations, the server device 112 can be a single computing device such as a computer server. In some implementations, the server device 112 can represent a plurality of computing device (e.g., a server farm). In some examples, server computing device working together to perform the actions of a server computer (e.g., cloud computing). In some implementations, the network 114 can be a public communication network (e.g., the Internet, cellular data network, dialup modems over a telephone network) or a private communications network (e.g., private LAN, leased lines).

A number of users 120a-120e of the client devices 102-110, respectively, access the server device 112 to use one or more computer-implemented services provided by one or more service provides. For example, the client devices 102-110 can execute web browser applications that can be used to access the services. In another example, the client devices 102-110 can execute software applications that are specific to the services (e.g., “apps” executing on smartphones). Example computer-implemented services can include an electronic messaging service, a chat service, an image sharing service, a document sharing service, a calendar sharing service and/or a social networking service.

The users 120a-120e can interact with the services using the respective client devices 102-110. For example, the users can participate in a social networking service hosted by the server device 112 by posting information, such as text comments (e.g., updates, announcements, replies), digital photos, videos, and/or other appropriate digital content. In some implementations, information can be posted on a user's behalf by systems and/or services external to the social network or the server device 112. For example, the user 120a may post a review of a movie to a movie review website, and with proper permissions that website may cross-post the review to the social network on the user's 120a behalf. In another example, a software application executing on a mobile device, with proper permissions, may use global positioning system (GPS) capabilities to determine the user's location and automatically update the social network with his location (e.g., “At Home”, “At Work”, “In Brownsdale, Minn.”).

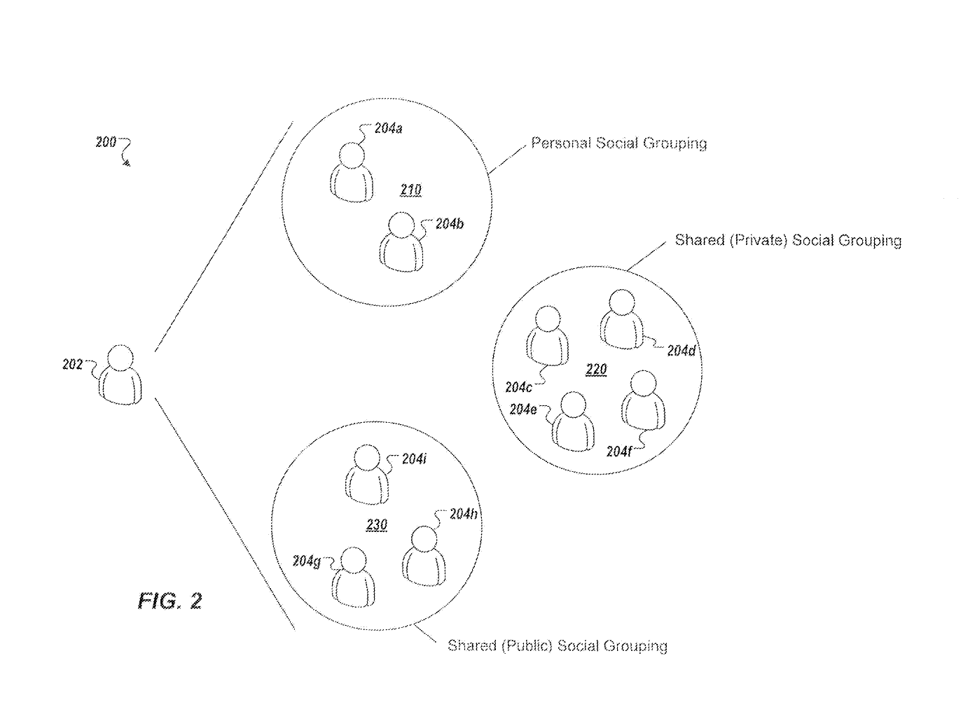

An example social networking service can enable users to grouping contacts into social groupings for sharing of digital content. For example, users 120a-120e interacting with the client devices 102-110 can use the social networking service hosted by the server device 112 to define one or more social groupings. In some examples, the social groupings can be used to organize and categorize the users' 120a-120e relationships to other users of the social network. Examples of the creation and use of social groupings are provided in the description of FIG. 2. A social grouping can function as a communication channel for distributing digital content to members of the social grouping.

In general, social groupings are categories or groupings to which a user can assign their contacts (e.g., members of a social network in which the user belongs, other contacts of the user) and better control the distribution and visibility of digital content (e.g., social networking posts). A social grouping can be provided as a data set defining a collection of contacts that may have some association with one another. Generally, a social grouping can be described from the perspective of an individual that is the center of a particular collection of socially interconnected people, or from the aggregate perspective of a collection of socially interconnected people. In some implementations, a social grouping can have narrowly defined boundaries, all of the members of the social grouping are at least familiar with one another, and permission may be required for a member to join a social grouping. In some implementations, a social grouping can have broadly defined boundaries where, for example, none of the members are familiar with one another, but there is a commonality between all members (e.g., ride the same bus, are at the same location, are attending the same event, frequent the same locations, partake in the same activities).

In some implementations, a social grouping provides a distribution list within a social networking environment that defines which users receive or are otherwise allowed to access digital content. Example digital content can include textual content (e.g., posted text), status updates (e.g., busy, available, offline, check-in status), images, videos, hyperlinks and the like. In some implementations, the digital content can include a corresponding access control list (ACL), discussed in further detail below, that defines which users are to receive and/or are able to access the digital content.

Through the creation and use of social groupings, the user can organize and categorize contacts into various different groupings that can be used to control the visibility and access those contacts have to the user's digital content (e.g., postings, digital pictures, videos, audio files, hyperlinks (e.g., uniform resource indicators (URIs)), and/or other content associated with the user's social networking profile). In some examples, the user can post an update or photo associated with an event to only an “event” grouping, and spare other contacts from seeing information that may not be relevant to them.

FIG. 2 is a diagram of an example social network 200 including social groupings. A user 202 is a member of a social network that supports the creation and use of social groupings (e.g., the social network provided by the server device 112 of FIG. 1). In the present example, the user 202 has a number of contacts 204a-204i with which the user 202 can have some form of direct or indirect social relationship (e.g., friends, friends-of-friends, coworkers, customers, teammates, clients, relatives, club members, classmates). The user 202 categorizes the contacts 204a-204i by assigning them to one or more social groupings, such as a social grouping 210, a social grouping 220, and a social grouping 230.

The social grouping 210 is a personal social grouping. In some implementations, personal social groupings are groupings created by and may be known only to the user 202 (e.g., the contacts 204a, 204b may receive no indication that they are in the user's 202 personal social grouping 210). In some implementations, personal social groupings are groupings created by the user 202 and may be known to the user 202 as well as the contacts (e.g., contacts 204a, 204b) that are members of the social grouping (e.g., the contacts 204a, 204b receive an indication that they have been added to the personal social grouping 210).

In some implementations, personal social groupings may be used to organize and categorize the contacts 204a-204i in ways that are relevant to the user 202. In some implementations, the user 202 may use personal social groupings to organize contacts in order to discretely target which of his contacts 204a-204h will see certain postings or have access to particular information. For example, the user 202 may be planning a surprise party for a small group of friends. As such, the user can organize contacts into “Surprise Party Attendees” and “Surprise Party Honorees” personal social groupings. By doing so, the user 202 may better target selected postings to the friends attending and/or helping to plan the surprise party (i.e., Surprise Party Attendees), while targeting selected postings to friends that are to be honored at the surprise party (i.e., Surprise Party Honorees) to maintain the integrity of the surprise.

The social grouping 220 is a shared private social grouping, which may also be referred to simply as a shared grouping. In general, shared private social groupings are social groupings that the user 202 creates and invites contacts to voluntarily join. Contacts that accept the invitation become members of the shared private social grouping. Members of a shared private social grouping can see information posted to that grouping by the user 202 and can post information to be shared with other members of the shared private social grouping. For example, the user 202 may tend to post a large number of jokes to the social network. However, while some of the contacts 204a-204i may find the jokes to be entertaining, others may find them to be simply annoying. Realizing this, the user 202 may create a “jokes” shared private social grouping and invite some or all of the contacts 204a-204i to join. With the “jokes” social grouping in place, the user 202 may post witticisms to the “jokes” grouping, and only those contacts who have accepted the invitation are able to see the user's 202 comicality. Similarly, members of the shared private social grouping are able to post messages to the grouping, and those posts are visible to other members of that grouping.

The social grouping 230 is a shared public social grouping. In general, shared public groupings are social groupings that the user 202 creates, and invites contacts to voluntarily join. Further, the existence of a shared public grouping is publicly available such that other users of the social networking service (e.g., not necessarily just the user's 202 contacts 204a-204i) may request to join the public social grouping. Members of shared public groupings may post information to, and see updates posted by, other members of the same public shared grouping. In some implementations, public shares groupings may be “fan” or “group” groupings (e.g., groupings dedicated to a particular place, event, product, movie, celebrity, sports team, company, concept, philosophy, organization, support network). For example, the user 202 may create a shared public grouping for his band, and fans of his act may join the grouping to discuss upcoming shows, download MP3s of the band's music, or post videos from recent concerts. In another example, the user 202 may create a shared public grouping for alumni of his high school graduating class, which his former classmates may find and join in order to stay in touch with one another and post pictures from their school days. Once a shared public grouping is created, in some implementations the user 202 can invite people to join the grouping. In some implementations, nonmembers of the grouping can request membership in the shared public grouping, and membership in a shared public grouping may be automatic upon request, or may require the user's 202 approval to become members of the shared public grouping.

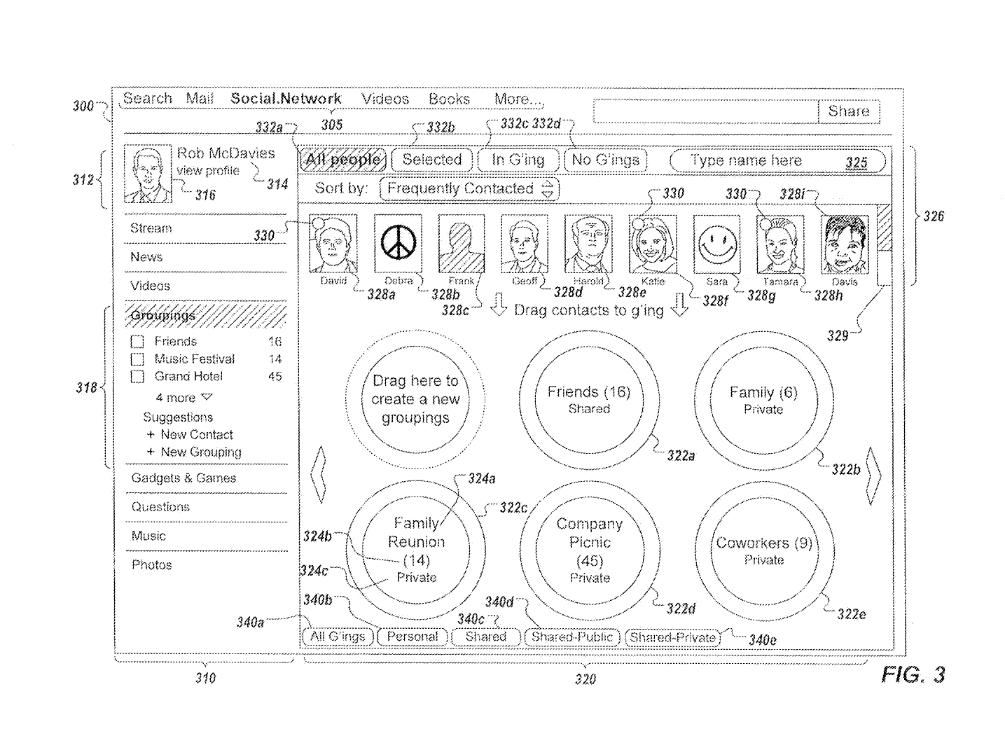

FIG. 3 depicts an example graphical user interface (GUI) 300 for creating, editing and/or maintaining social groupings. The GUI 300 can provide a social graph editor user interface (UI). In some implementations, the UI can be an interface presented by a purpose made social networking application, while in some implementations the UI can be one or more web pages of a social networking website displayed in a general purpose web browser.

The UI includes a number of selectable links presented in a menu bar 305. In the present example, the “Social Network” link has been selected by a user. This selection causes a web-based social networking application to be executed and a social network menu 310 to be displayed. The social network menu 310 includes a profile indicator 312 in which information such as a user name 314 and a user image 316 associated with the currently logged in user (Rob McDavies) are displayed.

The social network menu 310 also displays, among other items, a groupings submenu 318. The groupings submenu 318, when selected (e.g., as represented by the highlighting of the submenu's title), causes a social grouping display 320 to be displayed. The social grouping display 320 includes a number of social grouping representations 322a-322e that are visual representations of various social groupings that the user has created or is able to interact with. Each of the social grouping representations 322a-322e displays information about the social grouping it represents. For example, the social grouping representation 322c displays a name 324a (Family Reunion), a count 324b of the number of contacts associated with the social grouping, and an indication 324c of what type of social grouping that the social grouping representation is representative of (e.g., personal, private shared, public shared).

The social grouping display 320 also includes a contact display 326. The contact display 326 provides a graphical interface for viewing, selecting, and organizing items in the user's contact lists. A collection of contact icons 328a-328i represents the contacts or other entities (e.g., organizations, places, or other items) socially networked with the particular user. In some implementations, the icons can be digital images of the contacts that are represented (e.g., the icons 328a, 328d), arbitrary images (e.g., the icons 328b, 328g), or placeholders (e.g., when the contact has no image associated with their account, such as the icon 328c). Contacts who are members of one or more of the user's social groupings are identified by an indicator 330 superimposed upon the icons (e.g., the icons 328a, 328f, 328h). A scroll bar 329 is provided for the user to access additional contact icons that may not fit into the initial view.

A collection of filter buttons 332a-332d is provided to select subsets of the user's contacts. The “all people” filter button 332a, when selected, causes the contact display 326 to display the user's contacts with substantially no filtering. The “selected” filter button 332b, when selected, causes the contact display to display only the contacts that have been selected by the user. For example, the user may select multiple contacts while in an “all people” view, and then display only selected contacts by pressing the “selected” filter button 332b. The “in groupings” filter button 332c, when selected, causes the contact display 326 to display substantially only the contacts who share at least one social grouping with the user. The “no groupings” filter button 332d, when selected, causes the contact display 326 to display substantially only the contacts that is not in a social grouping with the user. A search input box 325 is provided so the user can type in all or part of a name, and the resulting matches will appear in the contact display 326.

The social grouping display 320 also includes a collection of social grouping filter buttons 340a-340d. The “all groupings” button 340a, when selected, causes the social grouping display 320 to display representations of substantially all of the social groupings that the user is able to interact with. The “personal” button 340b, when selected, causes the social grouping display 320 to display representations of substantially only the user's personal social groupings. The “shared” button 340c, when selected, causes the social grouping display 320 to display representations of substantially only the user's shared private social groupings. The “shared-public” button 340d, when selected, causes the social grouping display 320 to display representations of only the user's shared public groupings. The “query-based” button 340d, when selected, causes the social grouping display 320 to display only representations of query-based social groupings.

The social grouping representations 322c and 322d are graphical representations of communications channels provided as social groupings and created around respective, detected events. In the illustrated example, the social grouping representation 322c represents a social grouping created around a family reunion event and social grouping representation 322d represents a social grouping created around a company picnic event. For example, the logged in user, Rob McDavies, may have uploaded or published digital content indicative of his attendance at the family reunion and the company picnic. For example, digital image files, posts, and/or status updates provided by the logged in user could have been analyzed by a social networking server to recognize the occurrence of such events.

Implementations of the present disclosure are directed to automatically sharing, or publishing, digital content to one or more social networking services. Example digital content can include digital images, digital video, text, electronic documents and/or other appropriate digital content. Although implementations of the present disclosure are discussed with reference to the example social networking service discussed above, it is appreciated that implementations of the present disclosure can be realized using any appropriate social networking service.

In some implementations, digital content is automatically shared, or published, to the social networking service in response to generation of the digital content. In this manner, the digital content is automatically shared without manual user interaction explicitly triggering sharing of the digital content. In some examples, the user can generate digital content (provided in a computer-readable digital file) using a device. For example, the user can generate a digital image and/or a digital video (provided in a computer-readable digital image file or digital video file, respectively) using a capture device. Example capture devices can include digital cameras, computing devices including a digital camera and/or computing devices in communication with a digital camera. The capture device can be operated in an automatic sharing mode. In response to generation of the digital content and operation of the capture device in the automatic sharing mode, the digital file is automatically uploaded to the social networking service and the digital content automatically published to a viewing audience.

In some implementations, the user can set a sharing mode of the capture device. In some examples, the sharing mode can include the automatic sharing mode and a manual sharing mode. In some examples, the automatic sharing mode provides automatic sharing of digital content generated using the capture device. For example, when the capture device is in the automatic sharing mode, digital content (e.g., digital images, digital videos) is automatically uploaded and published to the social networking service in response to generation of the digital content. In some examples, the manual sharing mode provides manual sharing of digital content generated using the capture device. For example, when the capture device is in the manual sharing mode, user interaction is required to select digital content and instruct sharing of the digital content using the social networking service.

In some implementations, the user can define a distribution for automatic sharing of digital content. In some examples, the user can select one or more contacts within one or more social networking services, to which digital content is to be automatically distributed. In some examples, the user can select one or more social groupings to which the digital content is to be automatically shared using the social networking system. For example, the user can select a “Public” social grouping indicating that the digital content is to be publicly available to users of the social networking service. As another example, the user can select a “Family” social grouping indicating that the digital content is to be available to family members that are contacts of the user within the social networking service.

In some implementations, a default distribution for automatic sharing of digital content can be provided. In some examples, the default distribution can be provided in response to the device entering the automatic sharing mode. In some examples, the user can define the default distribution. In some examples, the user can edit the default distribution. For example, a default distribution can be a “Public” social grouping indicating that the digital content is to be publicly available to users of the social networking service. The user can edit the default distribution to include the “Public” social grouping and a “Family” social grouping. In this manner, the digital content is publicly indicating that the digital content that is shared using the edited default distribution is publicly available to users of the social networking service and is directly shared to family members that are contacts of the user within the social networking service.

In some implementations, one or more contacts and/or social groupings can be provided for automatic sharing based on proximity. In some examples, proximity is provided as a relative location of the one or more contacts and/or contacts within social groupings with respect to the computing device that is in the automatic sharing mode. In some examples, locations can be determined for each of the one or more contacts and/or contacts within social groupings as well as for the computing device that is in the automatic sharing mode. In some examples, locations can be determined based on one or more signals. Example signals can include Wifi connection signals, GPS signals and/or cellular triangulation signals. In some examples, if the location of a contact is within a threshold distance from the location of the computing device, the contact is included in the distribution for automatic sharing. In some examples, if the location of a contact is greater than a threshold distance from the location of the computing device, the contact is included in the distribution for automatic sharing.

Implementations of the present disclosure are discussed in further detail below by way of example. In the example discussed below, digital content includes digital images. It is appreciated, however, that implementations of the present disclosure can be realized with other appropriate digital content (e.g., digital videos, text, electronic documents).

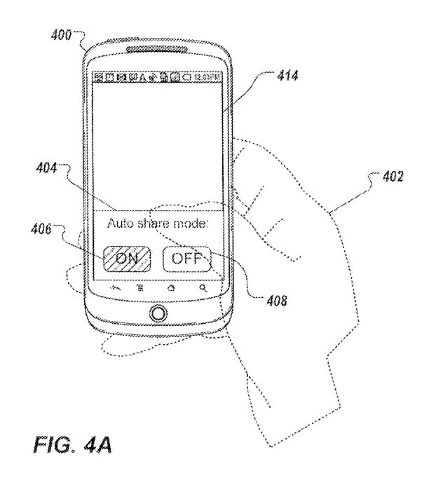

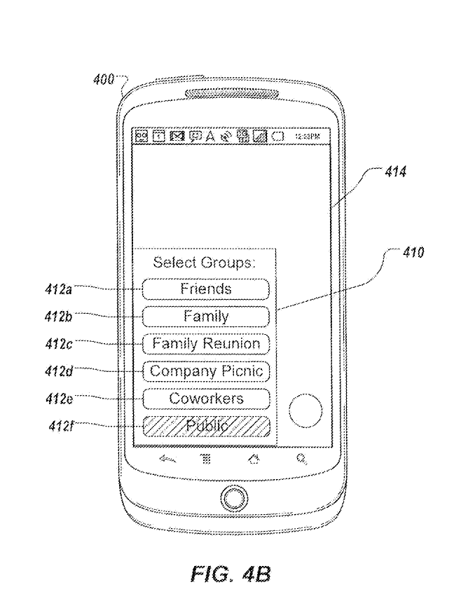

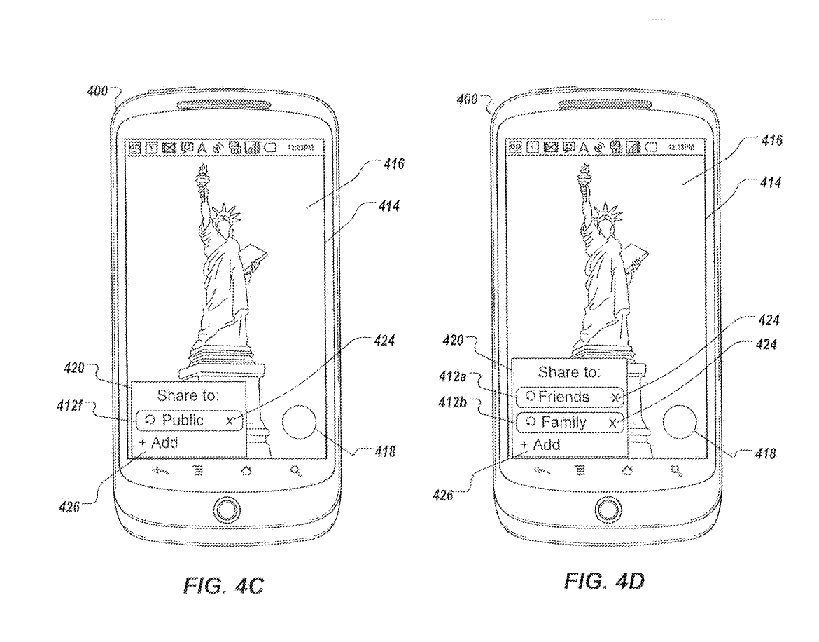

FIGS. 4A-4D depict an example mobile device 400 displaying an example interface for automatically sharing digital content. In some examples, a user 402 of the mobile device 400 can also be a user of a social networking service. In some examples, an application associated with the social networking service can be executed on the mobile device to enable automatic sharing of digital content from the mobile device 400. By way of example, the user 402 can include “Katie” (e.g., represented by the icon 328f in FIG. 3). Although a mobile device 400 is depicted in FIGS. 4A-4D, implementations of the present disclosure can be achieved using any appropriate computing device.

Referring to FIG. 4A, the user 402 can select a setting of an automatic sharing mode for the mobile device 400. In the depicted example, an interface 404 can be displayed on a display 414 and includes an ON setting 406 and an OFF setting 408. If the ON setting 406 is selected (as depicted in FIG. 4A), the mobile device 400 is operated in the automatic sharing mode such that digital images generated using the mobile device 400 are automatically shared to one or more associated social networking services. In this manner, additional user input is not required to share the digital images to the social networking services. For example, the user “Katie” can use the mobile device 400 to generate a digital image, which digital image can be automatically shared with contacts using the example social networking service discussed above. If the OFF setting 408 is selected, the mobile device 400 is operated in a manual sharing mode such that digital images generated using the mobile device 400 are not automatically shared to the social networking services. Consequently, explicit user input can be required in order to share the digital images using the social networking services.

Referring to FIG. 4B, an interface 410 can be displayed on the display 414 to enable the user 402 to identify one or more social groupings, with which digital content is to be automatically shared using the social networking service. In some examples, the interface 410 can be displayed in response to selection of the ON setting 406 from the interface 404 (depicted in FIG. 4A). In some implementations, the interface 410 includes icons associated with respective social groupings of the user 402 in the social networking service. In the depicted example, icons 412a-412f are displayed and each icon 412a-412f represents a social grouping defined by the user 402 in the social networking service. The user 402 can select one or more icons 412a-412f to define a distribution for automatic sharing of digital images captured using the mobile device 400. In the depicted example, the icon 412f (“Public”) is selected.

Referring now to FIGS. 4C and 4D, the user 402 can use the mobile device 400 to capture a digital image. In the depicted example, the user 402 can view a scene through a camera of the mobile device 400, which scene is displayed on the display 414. The user 402 can capture an image of the scene using a shutter button 418 that is displayed on the display 414. For example, the user 402 can tap the display 414 in a region occupied by the displayed shutter button 418 and, in response, a digital image of the scene can be generated. If the mobile device 400 is operating in the automatic share mode (i.e., ON setting), the digital image is automatically uploaded to and shared with the social networking service. In the depicted example, the scene includes the Statue of Liberty.

In some implementations, an indicator can be provided to alert the user 402 that the mobile device 400 is operating in the automatic share mode. In some examples, the indicator can include a visual and/or an audible indicator. For example, a border can be displayed about the periphery of the display 414 to visually indicate that the mobile device 400 is operating in the automatic share mode. As another example, a tone or other audible sound can be emitted from a speaker of the mobile device 400 to audibly indicate that the mobile device 400 is operating in the automatic share mode. In the depicted example, an interface 120 can be displayed to indicate that the mobile device 400 is operating in the automatic share mode. The interface 120 can display icons representing the one or more social groupings to which digital images are to be automatically shared. In the example of FIG. 4C, the interface 420 includes the icon 412f indicating that the mobile device 400 is operating in the automatic share mode and that digital images captured by the mobile device 400 will be publicly shared to the social networking service. In the example of FIG. 4D, the interface 420 includes the icons 412a, 412b indicating that the mobile device 400 is operating in the automatic share mode and that digital images captured by the mobile device 400 will be shared with members of the user's “Friends” and “Family” social groupings.

In some implementations, the user 402 can adjust the distribution before capturing a digital image. In some examples, the user 402 interact with (e.g., tap on) the interface 420 to display the interface 410 and select icons from the icons displayed in the interface 410. In some examples, the user 402 can interact with (e.g., tap on) a cancel graphic 424 associated with an icon to remove the respective social grouping from the distribution. In some examples, the interface 420 can include an add icon 426. The user 402 can interact with (e.g., tap on) the add icon 426 to add one or more social groupings to the distribution. For example, in response to user interaction with the add icon 426, the interface 410 can be displayed.

In the depicted example, the user 402 (e.g., Katie) can interact with (e.g., tap on) the shutter button 418 to capture a digital image of the Statue of Liberty. Once the digital image is captured, the corresponding digital image file is uploaded to the social networking service (e.g., to one or more servers hosting the social networking service). The digital image is then shared with social networking contacts associated with the social groupings identified in the interface 420.

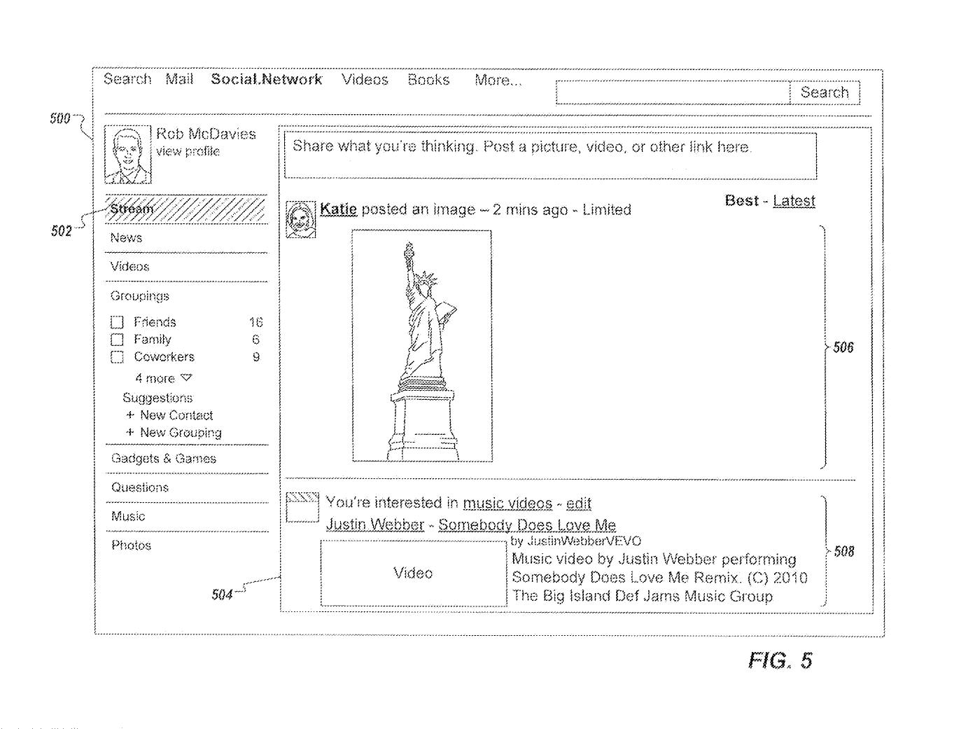

FIG. 5 depicts an example stream page 500 for a user of a social networking service. In some examples, the stream page 500 can be provided as a web page within a website of a social networking service, and can display digital content that has been shared with a user associated with the stream page 500. In the illustrated example, the example user includes “Rob McDavies” and the stream page 500 displays items (e.g., digital content) that other users have shared with the user and/or items that the user has shared with other users. The stream page 500 includes a social network menu 502 and an item region 504. Example items 506, 508 that have been distributed to the user are displayed in the item region 504. Generally, the items 506, 508 displayed in the item region 504 include digital content that is distributed to the user from contacts established within the social networking service. Although two items 506, 508 are depicted in FIG. 5, it is appreciated that the stream page 500 can display any number of items to the user.

In the illustrated example, FIG. 5, the digital image captured and published by the user 402 in FIGS. 4A-4D (i.e., Katie) is provided in the item 506. For example, the user “Rob McDavies” can be a member of one or more of the social groupings selected by the user 402 for automatic sharing. For example, Rob McDavies can be a member of Katie's defined “Friends” social grouping. Additionally, in this example, Katie, in FIG. 4D, selected to share digital images to “Friends” and “Family” social groupings. In the depicted example, when the digital image is captured, the corresponding digital image filed is automatically uploaded, and published to the selected social groupings within the social networking service.

In some implementations, digital content is automatically shared, or published, to the social networking service in response to the occurrence of or the attendance at an event. In some examples, the computer-implemented social networking service, a computer-implemented calendar service and/or a computer-implemented event service can be used to define an event. In some examples, the event can be defined based on one or more parameters. Example parameters can include time, date, location and name. In some examples, the time can be provided as a time range (e.g., 10 AM to 11 PM). In some examples, the date can be provided as a date range (e.g., Oct. 12, 2012 to Oct. 14, 2012). In some examples, the location can include a specific location (e.g., Company X, Building 12, Conference Room B). In some examples, the location can include a general location (e.g., Zilker Park).

In some examples, the event can be narrowly defined based on a plurality of parameters. For example, an event can be defined based on time, date, location and name (e.g., 10 AM on Oct. 12, 2012 at Company X, Building 12, Conference Room B for Company Meeting). In some examples, the event can be broadly defined based on a parameter. For example, an event can be defined based on name (e.g., Thanksgiving). In general, events can be defined with varying degrees of specificity based on the parameters associated with the event. In some examples, an event can be defined as a longer-timeline event based on location. For example, an event can be determined based on a location such that the event is deemed to be occurring when the computing device is at a particular location (e.g., share digital content to “Family” when in Hawaii).

In some implementations, an event can be defined by a user. For example, the user (e.g., an event host) can use one or more of the social networking service, the calendar service and the event service to define an event. In some examples, the user can define the event for the user's own consumption. For example, the user can define an event entitled “Thanksgiving.” In some examples, the user can defined the event for the consumption of the user and other users. For example, the user can define an event and can invite other users to the event. An example event can be defined as Thanksgiving, 2 PM to 8 PM on Thursday, Nov. 22, 2012 at 123 Maple Street.

In some implementations, a sharing mode of a device that is used to generate digital content can be switched to automatic sharing in response to occurrence of and/or attendance at an event. In some implementations, occurrence of and/or attendance at an event can be determined based on implicit indicators and/or explicit indicators. In some examples, an explicit indicator can include a user explicitly indicating that an event is occurring and/or that the user is in attendance at the event. For example, a user of a device can explicitly “check-in” at an event using one or more of the social networking service, the calendar service, the event service and/or a computer-implemented check-in service. In some examples, the check-in service can be provided as part of one or more of the social networking service, the calendar service and the event service. For example, a user can check into the event “Thanksgiving,” explicitly indicating that the event “Thanksgiving” is occurring and that the user is in attendance at the event “Thanksgiving.”

In some examples, implicit indicators can include comparisons between one or more actual parameters and one or more corresponding event parameters. In some examples, if one or more actual parameters are equal to, fall within or are sufficiently similar to respective one or more event parameters, it can be determined that the event is occurring and/or the user is in attendance at the event. Example actual parameters can include a current time, a current date and/or a current location of a device of the user. For example, the current time, the current date and the current location of the device can be determined to be 3 PM, Nov. 22, 2012 and 123 Maple Street, respectively. Consequently, it can be determined that the event “Thanksgiving” is occurring and/or that at least the device of the user, if not also the user, is in attendance at the event “Thanksgiving.” In some examples, the current location of the device can be determined based on one or more signals and/or the user checking into the location using the check-in service (as opposed to checking into the event itself). In some examples, the one or more signals can include global positioning satellite (GPS) signals and/or WiFi signals. For example, the current location of the device can be determined, or sufficiently approximated, relative to the event location based on GPS signals, WiFi signals and/or the user checking into the event location.

In some implementations, the distribution of automatically shared digital content can be provided based on one or more event-specific social groupings. In this manner, digital content generated during or at the event can be automatically shared to each of the one or more event-specific social groupings. In some examples, a user can define one or more social grouping that are associated with the event. In some examples, the user that defines the event can also define the one or more event-specific social groupings. In some examples, a user that is invited to, has RSVP'd to and/or is in actual attendance at the event can define one or more event-specific social groupings. In some examples, members of the one or more event-specific social groupings can include actual attendees of the event (e.g., users that are actually present at the event) and/or invited attendees of the event (e.g., users that were invited to the event, but are not present at the event). In some examples, and in response to the sharing mode being triggered to automatic sharing based on user attendance at or occurrence of an event, digital content that is generated using the user device can automatically be shared to the one or more social groupings, as discussed herein.

In some implementations, the one or more social groupings can be provided as default social groupings associated with the event. In some examples, a user can edit distribution from the default. For example, and in addition to, or in place of, the user can include one or more other social groupings for automatic distribution of digital content generated at or during the event. For example, a user can be attending an event “Family Reunion” and a “Family Reunion” social grouping can be associated with the event. In some examples, the “Family Reunion” social grouping includes members that are in actual attendance at the “Family Reunion” event. However, the user can determine that other family members are not in actual attendance at the “Family Reunion” event. Consequently, the user can edit the default social groupings for automatic sharing of digital content. For example, the user can edit the default social groupings to include a user-defined “Family” social grouping in addition to the “Family Reunion” social grouping. In this manner, digital content generated during the “Family Reunion” event can be shared to members in the user-defined “Family” social grouping that are not in actual attendance at the “Family Reunion” event (e.g., that are not member of the “Family Reunion” social grouping).

In some implementations, the sharing mode can be switched to manual sharing in response to ending of and/or departure from the event. In some implementations, ending of and/or departure from an event can be determined based on implicit indicators and/or explicit indicators. In some examples, an explicit indicator can include a user explicitly indicating that an event has ended and/or that the user has left the event. For example, a user of a device can explicitly “check-in” to another, different event, and/or “check-out” of the event using one or more of the social networking service, the calendar service, the event service and/or the check-in service. For example, a user can check out of the event “Thanksgiving,” explicitly indicating that the user is no longer in attendance at the event “Thanksgiving.”

In some implementations, if one or more actual parameters are not equal to, fall outside of or are sufficiently dissimilar to respective one or more event parameters, it can be determined that the event has ended and/or the user is no longer in attendance at the event. For example, the current time, the current date and the current location of a device of the user can be determined to be 9 PM, Nov. 22, 2012 and 456 Oak Street, respectively. Consequently, it can be determined that the event “Thanksgiving” is no longer occurring and that at least the device of the user, if not also the user, is no longer in attendance at the event “Thanksgiving.”

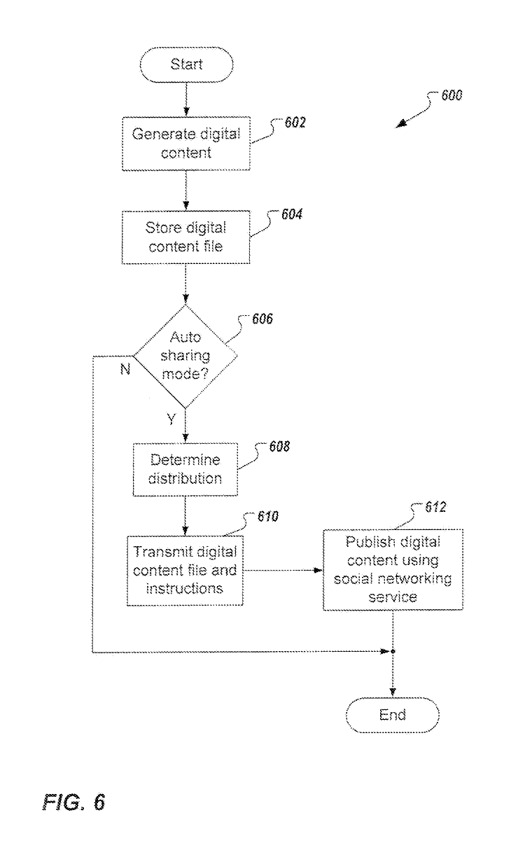

FIG. 6 is a flowchart of an example process 600 for automatically sharing digital content. In some implementations, the example process 600 can be provided using one or more computer programs executed using one or more computing devices (e.g., the computing device 400 of FIGS. 4A-4D, the server device 112 of FIG. 1).

Digital content is generated (602). For example, a computing device can be used to generate digital content. A digital content file is stored (604). For example, the digital content file can be stored in computer-readable memory and can include data associated with the digital content (e.g., digital image data). It is determined whether an automatic sharing mode is active (606). For example, it can be determined whether an automatic sharing mode of the computing device is in the ON setting. If the automatic sharing mode is not active, the example process 600 ends. If the automatic sharing mode is active, a distribution for the digital content is determined (608). In some examples, the distribution includes one or more social groupings to which the digital content is to be distributed. In some examples, a default distribution that is provided when the automatic sharing mode is activated. In some examples, the distribution includes a user-defined distribution (e.g., user-selected social groupings). The digital content file and sharing instructions are transmitted (610). For example, the computing device transmits the digital content filed and the distribution to one or more servers hosting a social networking service to instruct the social networking service to distribute the digital content based on the distribution. The digital content is published using the social networking service (612). For example, the one or more servers hosting the social networking service distribute the digital content to users of the social networking service that are identified in the distribution.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the invention can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclose can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

What is claimed is:

1. A computer-implemented method executed using one or more processors, the method comprising:
determining that a computing device is in attendance at an event based on detecting one or more actual parameters of the computing device corresponding with at least one event parameters defining the event;
automatically setting a sharing mode of the computing device to an automatic sharing mode, prior to generation of digital content by the computing device and in response to determining that the computing device is in attendance at the event, without user interaction to set the automatic sharing mode;
identifying a distribution for automatic sharing of the digital content using one or more social networking services, the distribution comprising one or more contacts of a user within the one or more social networking services;
determining that the digital content has been generated; and
in response to the automatic sharing mode and determining that the digital content has been generated, automatically transmitting, to one or more servers, a digital content file associated with the digital content and instructions for distributing the digital content using the one or more social networking services based on the distribution.

2. A computer-implemented method executed using one or more processors, the method comprising:
determining that an event is occurring based on detecting one or more actual parameters, including at least one of current time, current date or current location of a computing device in attendance at the event, wherein the one or more actual parameters correspond to at least one or more event parameters defining the event;
in response to determining that the event is occurring, automatically setting a sharing mode of the computing device to an automatic sharing mode, prior to generation of digital content by the computing device and without user interaction to set the automatic sharing mode;
determining that the digital content has been generated; and
in response to the automatic sharing mode and determining that the digital content has been generated:
automatically transmitting, to one or more servers, a digital content file associated with the digital content and instructions for distributing the digital content using one or more social networking services.

3. The method of claim 2, wherein the digital content is distributed based on a default distribution, the default distribution being an event-specific distribution.

4. The method of claim 3, further comprising receiving first input, the first input editing the default distribution to provide an edited distribution, wherein the digital content is distributed based on the edited distribution.

5. The method of claim 4, wherein the edited distribution comprises the event-specific distribution and a user-defined distribution.

6. The method of claim 5, wherein one or more users of the user-defined distribution are absent from the event-specific distribution.

7. The method of claim 2, further comprising, in response to setting the automatic sharing mode, generating an indicator, the indicator indicating that the computing device is operational in the automatic sharing mode.

8. The method of claim 7, wherein the indicator comprises a visual indicator that is displayed on a display of the computing device.

9. The method of claim 7, wherein the indicator comprises an audible indicator that is emitted from the computing device.

10. The method of claim 2, further comprising displaying an interface on a display of the computing device, the interface comprising one or more icons, each icon being selectable to define a distribution for digital content that is to be automatically shared using the computing device.

11. The method of claim 10, wherein at least one icon of the one or more icons graphically represents a social grouping defined by a user of the computing device within at least one of the one or more social networking services.

12. The method of claim 10, wherein the one or more icons graphically represent respective social groupings defined by a user of the computing device within at least one of the one or more social networking services.

13. The method of claim 2, further comprising receiving first input, the first input comprising selection of a manual sharing mode of the computing device such that user input is required to transmit, to the one or more servers, digital content files associated with digital content and instructions for distributing the digital content using the one or more social networking services.

14. The method of claim 2, wherein the digital content comprises at least one of a digital image and a digital video.

15. The method of claim 2, wherein setting the sharing mode of a the computing device to the automatic sharing mode is further in response to determining that the user is in attendance at the event.

16. The method of claim 15, wherein determining that the user is in attendance at the event is based on at least one of one or more implicit signals and one or more explicit signals.

17. (canceled)

18. (canceled)

19. The method of claim 2, wherein determining that the event is occurring comprises comparing the one or more event parameters to a corresponding one of the one or more actual parameters.

20. A system comprising:
one or more processors configured to interact with a computer storage medium in order to perform operations comprising:
determining that an event is occurring based on detecting one or more actual parameters, including at least one of current time, current date or current location of a computing device in attendance at the event, wherein the one or more actual parameters correspond to at least one or more event parameters defining the event;
in response to determining that the event is occurring, automatically setting a sharing mode of the computing device to an automatic sharing mode, prior to generation of digital content by the computing device and without user interaction to set the automatic sharing mode;
determining that the digital content has been generated; and
in response to the automatic sharing mode and determining that the digital content has been generated:
automatically transmitting, to one or more servers, a digital content file associated with the digital content and instructions for distributing the digital content using the one or more social networking services.

21. The method of claim 2, further including:
determining the event has ended based on detecting one or more actual parameters, including at least one of current time, current date and current location of the computing device, wherein the one or more actual parameters do not correspond to respective of the event parameters defining the event, and
in response to determining that the event has ended, automatically setting the sharing mode to off.

22. The method of claim 2, wherein the instructions for distributing includes instructions for streaming the digital content on a stream page of at least one of the one or more social networking services.
